(19) United States
(12) Patent Application Publication
(10) Pub. No.: US 2009/0194211 A1
(43) Pub. Date: Aug. 6, 2009

(54) TIRE TREAD GROOVES WITH TEXTURED BASES

(76) Inventor: John Alan Howald, North Canton, OH (US)

Correspondence Address: THE GOODYEAR TIRE & RUBBER COMPANY;INTELLECTUAL PROPERTY DEPARTMENT 823, 1144 EAST MARKET STREET, AKRON, OH, 44316-0001, US

(21) Appl. No.: 12/024,254

(22) Filed: Feb. 1, 2008

(51) Int. Cl. B60C 11/03

(52) U.S. Cl. 152/209.1

(57) ABSTRACT

A pneumatic tire includes an axis of rotation and a tread. The tread has a plurality of traction elements, a circumferential groove, and a lateral groove. The circumferential groove has a base interposed between radially extending sides formed by side walls of the traction elements. The lateral groove has a base interposed between radially extending sides formed by side walls of the traction elements. The tire is further characterized by the bases of the circumferential groove and the lateral groove each defining a matrix of circumferentially extending rectangular ramp structures, one ramp structure of the plurality extending circumferentially, from a radially inner first end portion, in a direction of rotation of the tire and radially outward to a radially outer second end portion, the radially outer second end portion defining an edge portion extending parallel to the axis of rotation of the tire, the edge portion improving traction of the tire and evacuation of the circumferential and lateral grooves.

### FIELD OF THE INVENTION

The present invention is directed to the tread of a pneumatic tire. More specifically, the present invention is directed to light truck and passenger vehicle tires and texturing of the base of the grooves of such tread.

### BACKGROUND OF THE INVENTION

Over the last twenty years, off-road vehicle recreational activities have become increasingly popular. The number of off-road sporting events and rock crawling competitions has increased. Tires suitable for such events are typically heavily lugged tires, with large spacing for improved traction and a high number of biting surfaces to enable the tire to both grip the uneven terrain and to throw out any mud. Those tires used almost exclusively for such sporting events are manufactured with an enhanced construction to improve durability under severe conditions.

Because of the popularity of such events, the look of the off-road tire has transitioned into use for conventional vehicle use. Light truck and passenger vehicle tires with a more rugged look have become increasingly popular and when mounted on light trucks and SUV's enable the operator to drive in limited off-road conditions and to participate in off-road recreational activities. The widely spaced lugs of such tires increase the possibility of material buildup between the lugs during use in areas with mud or other loose ground materials. Such buildup decreases the traction performance under these circumstances.

### SUMMARY OF THE INVENTION

The present invention is directed to a pneumatic tire comprising an axis of rotation and a tread. The tread has a plurality of traction elements, a circumferential groove, and a lateral groove. The circumferential groove has a base interposed between radially extending sides formed by side walls of the traction elements. The lateral groove has a base interposed between radially extending sides formed by side walls of the traction elements. The tire is further characterized by the bases of the circumferential groove and the lateral groove each defining a matrix of circumferentially extending rectangular ramp structures, one ramp structure of the matrix extending circumferentially, from a radially inner first end portion, in a direction of rotation of the tire and radially outward to a radially outer second end portion, the radially outer second end portion defining an edge portion extending parallel to the axis of rotation of the tire, the edge portion improving traction of the tire and evacuation of the circumferential and lateral grooves.

In one aspect of the disclosed invention, the edge portion of each ramp structure is linear and the second end portion extends radially inward from the edge portion to the first end portion of a circumferentially adjacent ramp structure. Each ramp structure has a planar, inclined surface extending circumferentially from the first end portion to the second end portion.

In another aspect of the invention, a second ramp structure of the matrix extends circumferentially, from a radially outer first end portion, in a direction of rotation of the tire and radially inward to a radially inner second end portion, the radially outer first end portion defining a second edge portion extending parallel to the axis of rotation of the tire. The second edge portion improves traction of the tire and evacuation of the circumferential and lateral grooves. The first ramp structure and the second ramp structure are disposed axially adjacent each other.

In another aspect of the invention, the edge portion of each ramp structure is concave toward the axis of rotation of the tire and the second end portion extends radially inward from the edge portion to the first end portion of a circumferentially adjacent ramp structure. Each ramp structure has an inclined and rounded surface extending circumferentially from the first end portion to the second end portion. A second ramp structure of the matrix extends circumferentially, from a radially outer first end portion, in a direction of rotation of the tire and radially inward to a radially inner second end portion. The radially outer first end portion defines a second edge portion concave away from the axis of rotation of the tire and extending axially and radially relative to the axis of rotation of the tire. The second edge portion improves traction of the tire and evacuation of the circumferential and lateral grooves. The first ramp structure and the second ramp structure are disposed axially adjacent each other.

In another aspect of the invention, the edge portion of each ramp structure is saw-toothed and the second end portion extends radially inward from the saw-toothed edge portion to the first end portion of a circumferentially adjacent ramp structure. Each ramp structure has a planar inclined surface extending circumferentially from the first end portion to the second end portion. A second ramp structure of the matrix extends circumferentially, from a radially outer first end portion, in a direction of rotation of the tire and radially inward to a radially inner second end portion. The radially outer first end portion defines a second saw-toothed edge portion extending generally parallel to the axis of rotation of the tire. The second saw-toothed edge portion improves traction of the tire and evacuation of the circumferential and lateral grooves. The first ramp structure and the second ramp structure are disposed axially adjacent each other.

In another aspect of the invention, the edge portion of each ramp structure has multiple cylindrical projections and the second end portion extends radially inward from the edge portion to the first end portion of a circumferentially adjacent ramp structure. Each ramp structure has a planar inclined surface extending circumferentially from the first end portion to the second end portion. A second ramp structure of the matrix extends circumferentially, from a radially outer first end portion, in a direction of rotation of the tire and radially inward to a radially inner second end portion. The radially outer first end portion defines a second edge portion extending generally parallel to the axis of rotation of the tire. The second edge portion improves traction of the tire and evacuation of the circumferential and lateral grooves. The first ramp structure and the second ramp structure are disposed axially adjacent each other.

### DEFINITIONS

The following definitions are controlling for the disclosed invention.

“Apex” refers to a wedge of rubber placed between the carcass and the carcass turnup in the bead area of the tire, usually used to stiffen the lower sidewall of the tire.

“Aspect ratio” of the tire means the ratio of its section height (SH) to its section width (SW) multiplied by 100% for expression as a percentage.

“Annular” means formed like a ring.

“Axial” and “axially” mean lines or directions that are parallel to the axis of rotation of the tire; synonymous with “lateral” and “laterally”.

“Bead” means that part of the tire comprising an annular tensile member wrapped by ply cords and shaped, with or without other reinforcement elements such as flippers, chippers, apexes, toe guards and chafers, to fit the design rim.

“Belt reinforcing structure” means at least two layers of plies of parallel cords, woven or unwoven, underlying the tread, unanchored to the bead, and having both left and right cord angles in the range from 17 degrees to 27 degrees with respect to the equatorial plane of the tire.

“Belt structure” means at least two annular layers or plies of parallel cords, woven or unwoven, underlying the tread, unanchored to the bead, and having both left and right cord angles in the range from 17 degrees to 27 degrees with respect to the equatorial plane of the tire.

“Bias ply tire” means a tire having a carcass with reinforcing cords in the carcass ply extending diagonally across the tire from bead core to bead core at about a 25°-50° angle with respect to the equatorial plane of the tire. Cords run at opposite angles in alternate layers.

“Breakers” refers to at least two annular layers or plies of parallel reinforcement cords having the same angle with reference to the equatorial plane of the tire as the parallel reinforcing cords in carcass plies.

“Buffed” means a procedure whereby the surface of an elastomeric tread or casing is roughened. The roughening removes oxidized material and permits better bonding.

“Building Drum” refers to a cylindrical apparatus on which tire components are placed in the building of a tire. The “Building Drum” may include apparatus for pushing beads onto the drum, turning up the carcass ply ends over the beads, and for expanding the drum for shaping the tire components into a toroidal shape.

“Carcass” means the tire structure apart from the belt structure, tread, undertread, and sidewall rubber over the plies, but including the beads.

“Casing” means the carcass, belt structure, beads, sidewalls, and all other components of the tire including a layer of unvulcanized rubber to facilitate the assembly of the tread, the tread and undertread being excluded. The casing may be new, unvulcanized rubber or previously vulcanized rubber to be fitted with a new tread.

“Center plane” means the plane perpendicular to the axis of rotation of the tread and passing through the axial center of the tread.

“Circumferential” means lines or directions extending along the perimeter of the surface of the annular tire parallel to the Equatorial Plane (EP) and perpendicular to the axial direction.

“Chafers” refers to narrow strips of material placed around the outside of the bead to protect cord plies from the rim, distribute flexing above the rim, and to seal the tire.

“Chippers” mean a reinforcement structure located in the bead portion of the tire.

“Cord” means one of the reinforcement strands of which the plies in the tire are comprised.

“Design rim” means a rim having a specified configuration and width. For the purposes of this specification, the design rim and design rim width are as specified by the industry standards in effect in the location in which the tire is made. For example, in the United States, the design rims are as specified by the Tire and Rim Association. In Europe, the rims are as specified in the European Tyre and Rim Technical Organisation—Standards Manual and the term design rim means the same as the standard measurement rims. In Japan, the standard organization is The Japan Automobile Tire Manufacturer's Association.

“Design rim width” is the specific commercially available rim width assigned to each tire size and typically is between 75 and 90% of the specific tire's section width.

“Equatorial plane (EP)” means the plane perpendicular to the tire's axis of rotation and passing through the center of its tread.

“Filament” refers to a single yarn.

“Flipper” refers to reinforcing fabric around the bead wire for strength and to tie the bead wire into the tire body.

“Footprint” means the contact patch or area of contact of the tire tread with a flat surface at zero speed and under normal load and pressure.

“Groove” means an elongated void area in a tread that may extend circumferentially or laterally about the tread in a straight, curved, or zigzag manner. Circumferentially and laterally extending grooves sometimes have common portions. The “groove width” is equal to tread surface occupied by a groove or groove portion, the width of which is in question, divided by the length of such groove or groove portion; thus, the groove width is its average width over its length. Grooves may be of varying depths in a tire. The depth of a groove may vary around the circumference of the tread, or the depth of one groove may be constant but vary from the depth of another groove in the tire. If such narrow or wide grooves are of substantially reduced depth as compared to wide circumferential grooves which they interconnect, they are regarded as forming “tie bars” tending to maintain a rib-like character in the tread region involved.

“Inboard side” means the side of the tire nearest the vehicle when the tire is mounted on a wheel and the wheel is mounted on the vehicle.

“Inner” means toward the inside of the tire and “outer” means toward its exterior.

“Lateral” means an axial direction.

“Lateral edge” means the axially outermost edge of the tread as defined by a plane parallel to the equatorial plane and intersecting the outer ends of the axially outermost traction lugs at the radial height of the inner tread surface.

“Leading” refers to a portion or part of the tread that contacts the ground first, with respect to a series of such parts or portions, during rotation of the tire in the direction of travel.

“Net contact area” means the total area of ground contacting tread elements between the lateral edges around the entire circumference of the tread divided by the gross area of the entire tread between the lateral edges.

“Net-to-gross ratio” means the ratio of the tire tread rubber that makes contact with a hard flat surface while in the footprint, divided by the area of the tread in the footprint, including non-contacting portions such as grooves.

“Nominal rim diameter” means the average diameter of the rim flange at the location where the bead portion of the tire seats.

“Normal inflation pressure” refers to the specific design inflation pressure and load assigned by the appropriate standards organization for the service condition for the tire.

“Normal load” refers to the specific design inflation pressure and load assigned by the appropriate standards organization for the service condition for the tire.

“Outboard side” means the side of the tire farthest away from the vehicle when the tire is mounted on a wheel and the wheel is mounted on the vehicle.

“Pantographing” refers to the shifting of the angles of cord reinforcement in a tire when the diameter of the tire changes, e.g. during the expansion of the tire in the mold.

“Ply” means a continuous layer of rubber-coated parallel cords.

“Pneumatic tire” means a laminated mechanical device of generally toroidal shape (usually an open torus) having beads and a tread and made of rubber, chemicals, fabric and steel or other materials. When mounted on the wheel of a motor vehicle, the tire through its tread provides traction and contains the fluid or gaseous matter, usually air, that sustains the vehicle load.

“Radial” and “radially” mean directions radially toward or away from the axis of rotation of the tire.

“Section height” means the radial distance from the nominal rim diameter to the outer diameter of the tire at its equatorial plane.

“Shoulder” means the upper portion of sidewall just below the tread edge. Tread shoulder or shoulder rib means that portion of the tread near the shoulder.

“Tread Width” means the arc length of the tread surface in the axial direction, that is, in a plane parallel to the axis of rotation of the tire.

“Undertread” refers to a layer of rubber placed between a reinforcement package and the tread rubber in a tire.

“Unit tread pressure” means the radial load borne per unit area (square centimeter or square inch) of the tread surface when that area is in the footprint of the normally inflated and normally loaded tire.

“Wedge” refers to a tapered rubber insert, usually used to minimize curvature of a reinforcing component, e.g. at a belt edge.

“Wings” means the radial inward extension of the tread located at axial extremes of the tread, the inner surface of the wing being an extension of the inner casing contacting surface of the tread.

“Year-round” means a full calendar year through each season. For example, a snow tire is not designed for year-round use since it creates objectionable noise on dry road surfaces and is designed to be removed when the danger of snow is passed.

### BRIEF DESCRIPTION OF THE DRAWINGS

The invention will be described by way of example and with reference to the accompanying drawings in which:

FIG. 1 is a schematic radial view of a tire and tire tread in accordance with the present invention;

FIG. 2 is a detailed radial view of the tire tread of the tire of FIG. 1;

FIG. 3 is a detailed schematic cross-sectional view of a section of the tire tread of FIG. 1;

FIG. 4 is a detailed schematic isometric view of a portion of a tire tread in accordance with one aspect of the present invention;

FIG. 5 is a detailed schematic isometric view of a portion of a tire tread in accordance with another aspect of the present invention;

FIG. 6 is a detailed schematic isometric view of a portion of a tire tread in accordance with still another aspect of the present invention; and

FIG. 7 is a detailed schematic isometric view of a portion of a tire tread in accordance with yet another aspect of the present invention.

### DETAILED DESCRIPTION OF AN EXAMPLE EMBODIMENT OF THE INVENTION

The following language is of the best presently contemplated mode or modes of carrying out an example embodiment of the invention. This description is made for the purpose of illustrating the general principals of the invention and should not be taken in a limiting sense. The scope of the invention is best determined by reference to the appended claims.

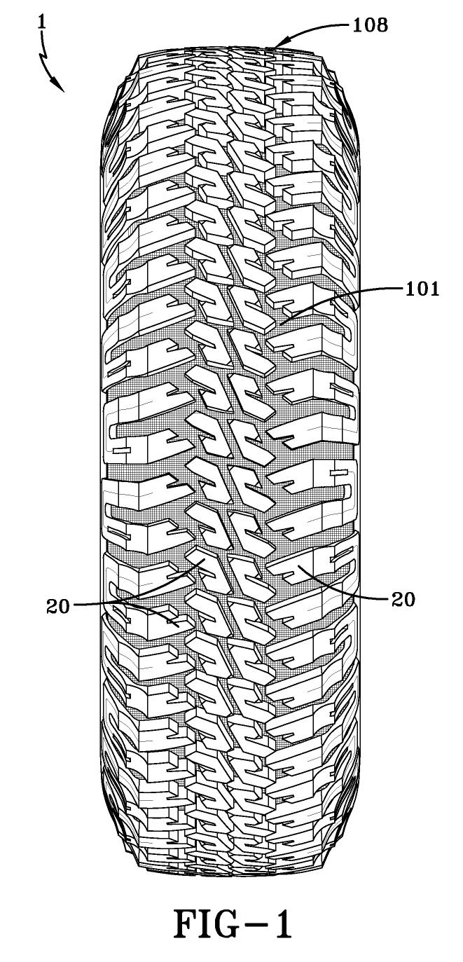

FIGS. 1-3 illustrate an example light truck tire 1. The tire 1 has a carcass 100 that extends between, and is turned up around, a pair of opposing beads 102. The carcass 100 is also located radially outward of an innerliner 104 that extends between opposing bead toes 106. A belt structure 110 is located radially outward of the carcass 100 and radially inward of the tire tread 108. The belt structure 110 comprises multiple plies of reinforcing cords. The example tire tread 108, as illustrated, has an on-road central tread portion 10 having a tread width TW, defined by a pair of first and second lateral edges 12, 14. Axially outward of each lateral edge 12, 14 is a shoulder region S.

The central tread portion 10 is laterally divided into three tread zones, A, B, C. The central tread zone A is positioned axially between a pair of first and second circumferential grooves 16, 18. The first shoulder zone B is located between the first lateral edge 12 and the first circumferential groove 16. The second, opposite shoulder zone C is located between the second lateral edge 14 and the second circumferential groove 18. The central tread zone A has a width greater than each of the first and second shoulder zones B, C, while the first and second shoulder zones B, C each have the same width (FIG. 1).

The central tread zone A has a plurality of ground engaging traction elements 20 separated axially by the first and second circumferential grooves 16, 18, and a central circumferential groove 22. The plurality of ground engaging traction elements 20 are further circumferentially separated by lateral grooves 24. Each traction element 20 extends radially outwardly from a tread base 60 to an outer tread surface 62.

In each shoulder zone B, C, a plurality of ground engaging traction elements 26, 28 are separated by lateral grooves 30. The lateral grooves 30 intersect and join with the lateral grooves 24 of the central tread zone A to form an axially continuous lateral groove path across the tread width TW (FIGS. 1 & 2). The traction elements 26, 28 of each shoulder zone B, C extend laterally across each shoulder zone. The traction elements 26 have a greater lateral width than the traction elements 28. The traction elements 26 extend laterally from their axially outer edges 31, coincident with the lateral edges 12, 14 of each shoulder zone B, C, axially and inwardly toward an equatorial plane EP of the tire 1. Circumferentially adjacent each longer traction element 26 is a shorter traction element 28. The shorter traction elements 28 have axially outer edges 32 spaced axially inward from the lateral edges 12, 14 of each shoulder zone B, C and the coincident axially outer edges 31 of the longer traction elements 26. The adjacent shorter traction elements 28 extend axially and inwardly toward the equatorial plane EP of the tire 1. Axially inner ends of both types of traction elements 26, 28 are axially aligned (FIGS. 1 & 2).

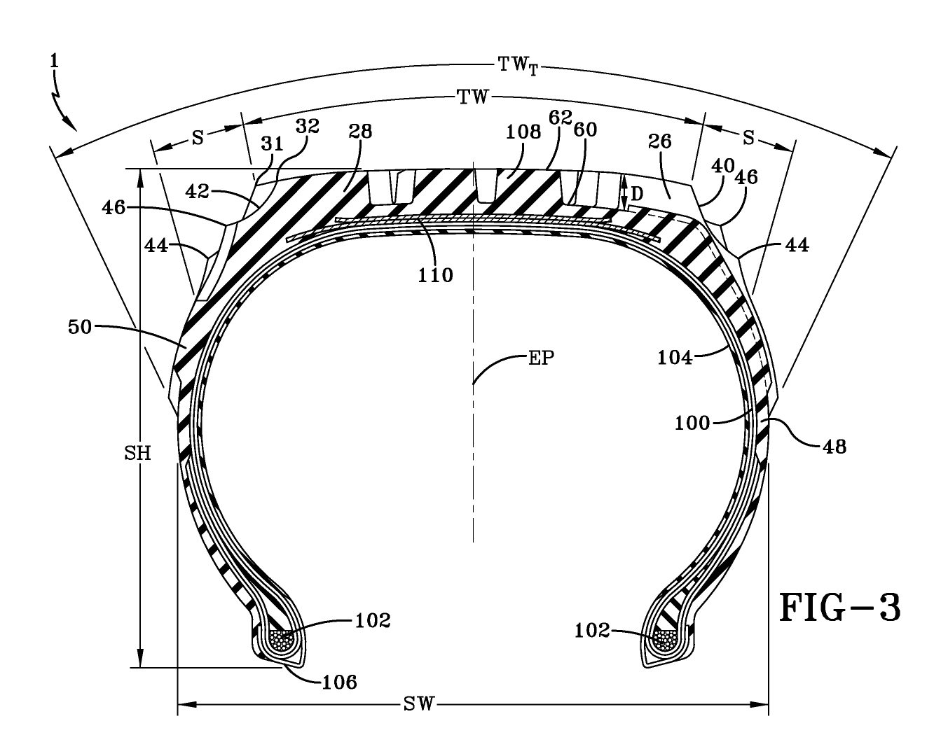

One of the primary features of this example tread is that it extends beyond the lateral edges 12, 14 thereby providing off-road performance characteristics. As seen in the cross-sectional view of FIG. 3, the shoulder traction elements 26, 28 begin at a location at or above the location of the maximum section width SW of the tire 1 and accordingly define a total effective tread width TW_{T}. The shoulder regions S of the tire 1 extend axially outward from the tread width TW, and terminate axially inward of the edges of the total effective tread width TW_{T}. The tread width TW and the shoulder regions S have an axial width less than the total effective tread width TW_{T} and have a radial height of 25% or less of the section height SH of the tire 1, as measured from the bead toes 106 to the location of the maximum radial height of the tread measured at the equatorial plane EP.

The traction elements 26, 28 protrude outwardly and radially from the tread base 60 and provide tractional leading or biting edges 36. Since the traction elements 26, 28 extend through the shoulder regions S of the tire 1, additional leading edges 38 are provided by concave portions 40, 42, as best seen in FIG. 3. Each traction element 26, 28 extends from the axially outer edges 31, 32 to an extension 44, 46 radially outward of a radially innermost portion of the shoulder regions S. Radially inward of each concave portion 40, 42, each traction element 26, 28 further extends from the shoulder regions S down into the tire sidewalls 48 to form the edges of the total effective tread width TW_{T}. The traction elements 26, 28 at this location have a radial height outward from the tire sidewall surface of at least ⅓ a tread depth D as measured from the tread base 60.

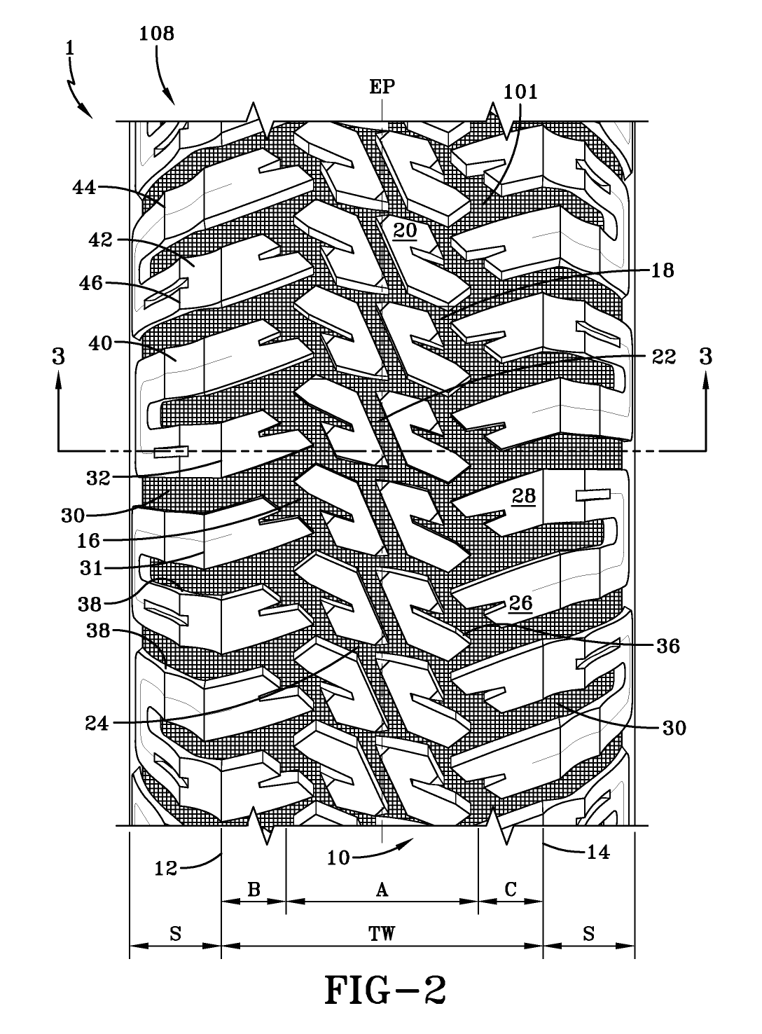

As the block elements 26, 28 extend through the shoulder regions S and down into the tire sidewalls 48, the lateral grooves 30 may also be viewed as extending into the shoulder regions S and down into the tire sidewalls 48. The longer block elements 26 and the shorter block elements 28 are connected by a circumferentially extending element 50. Connecting the traction elements 26, 28 provides additional stability in the shoulder regions S. The circumferentially adjacent connecting elements 50 are radially offset, as seen in FIGS. 2 and 3.

The present invention is directed to a pneumatic tire 1 comprising an axis of rotation and the example tread 108 described above. As described above, the tread 108 has a plurality of traction elements 20, a circumferential groove 16, 18, or 22, and a lateral groove 24 or 30. The circumferential groove 16, 18, 22 has a base 25 interposed between radially extending sides 21 formed by side walls of the traction elements 20. The lateral groove 24, 30 also has a base 25 interposed between radially extending sides 21 formed by side walls of the traction elements 20. The tire 1 is further characterized, in accordance with the present invention, by the bases 25 of the circumferential groove 16, 18, 22 and the lateral groove 24, 30 each defining a matrix 101 of circumferentially extending rectangular ramp structures 110, 210. A ramp structure 110 of the matrix 101 extends circumferentially, from a radially inner first end portion 112, in a direction of rotation 3 of the tire 1 and radially outward to a radially outer second end portion 114. The radially outer second end portion 114 defines an edge portion 116 extending parallel to the axis of rotation of the tire 1. The edge portion 116 improves traction of the tire 1 and evacuation of the circumferential and lateral grooves 16, 18, 22, 24, 30.

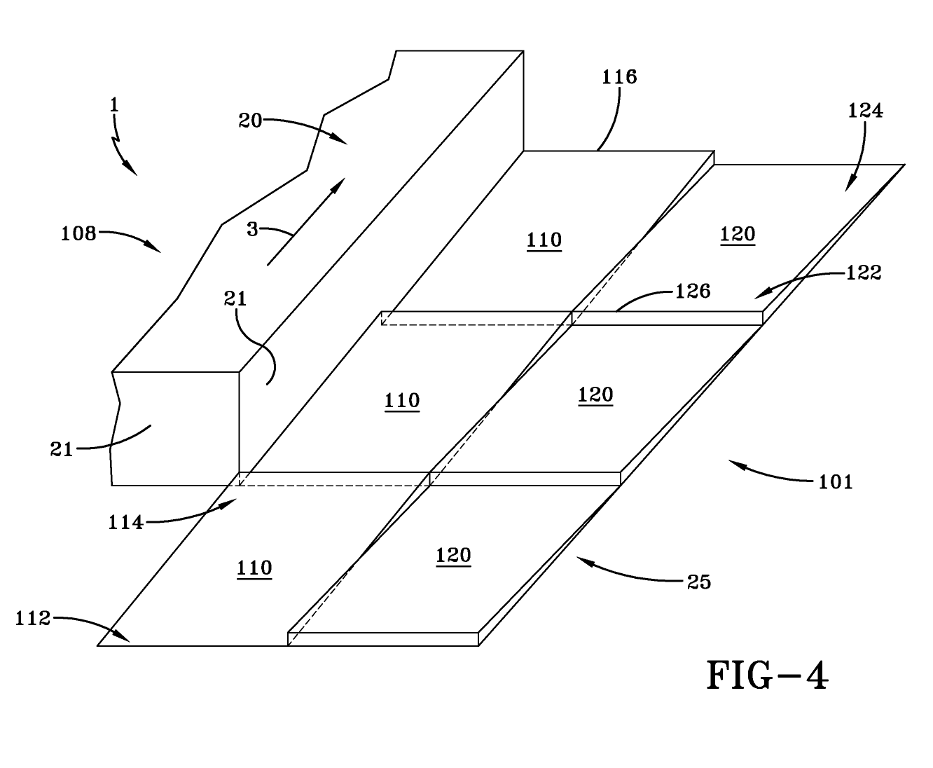

In one aspect of the disclosed invention, the edge portion 116 of the ramp structure 110 is linear (FIG. 4) and the second end portion 116 extends radially inward (as much as 5/32″) from the edge portion to the first end portion 112 of a circumferentially adjacent identical ramp structure 110. Each ramp structure 110 has a planar, inclined surface extending circumferentially from the first end portion 112 to the second end portion 114.

In another aspect of the invention, a second ramp structure 120 of the matrix 101 extends circumferentially, from a radially outer first end portion 122, in a direction of rotation 3 of the tire 1 and radially inward (as much as 5/32″) to a radially inner second end portion 124. The radially outer first end portion 122 defines a second edge portion 126 extending parallel to the axis of rotation of the tire 1. The second edge portion 126 improves traction of the tire 1 and evacuation of the circumferential and lateral grooves 16, 18, 22, 24, 30. The first ramp structure 110 and the second ramp structure 120 are disposed axially adjacent each other.

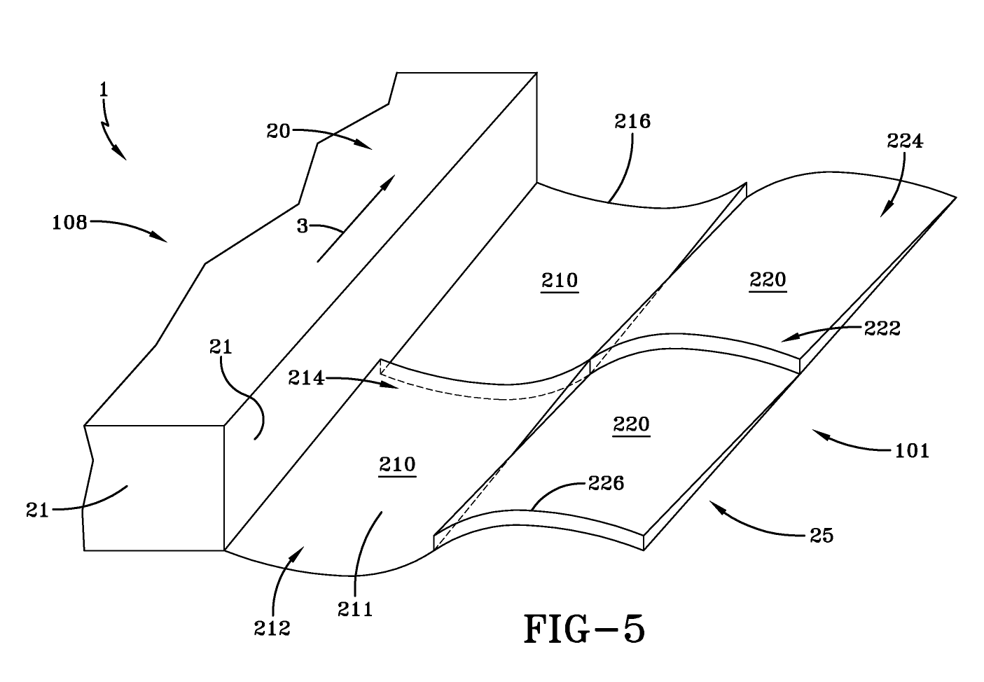

In another aspect of the invention, a curved edge portion 216 of a ramp structure 210 is concave (not shown) or convex (FIG. 5) toward the axis of rotation of the tire 1 and extends axially and radially relative the axis of rotation of the tire. A second end portion 214 extends radially inward (as much as 5/32″) from the edge portion to a first end portion 212 of a circumferentially adjacent identical ramp structure 210. The ramp structure 210 has an inclined and rounded surface 211 extending circumferentially from the first end portion 212 to the second end portion 214. A second ramp structure 220 of the matrix 101 extends circumferentially, from a radially outer first end portion 222, in a direction of rotation of the tire 1 and radially inward (as much as 5/32″) to a radially inner second end portion 224. The second ramp structure 220 similarly defines an inclined and rounded surface. The radially outer first end portion 222 defines a second curved edge portion 226 convex (not shown) or concave (FIG. 5) away from the axis of rotation of the tire 1 and extending axially and radially relative to the axis of rotation of the tire 1. The second edge portion 226 improves traction of the tire 1 and evacuation of the circumferential and lateral grooves 16, 18, 22, 24, 30. The first ramp structure 210 and the second ramp structure 220 are disposed axially adjacent each other.

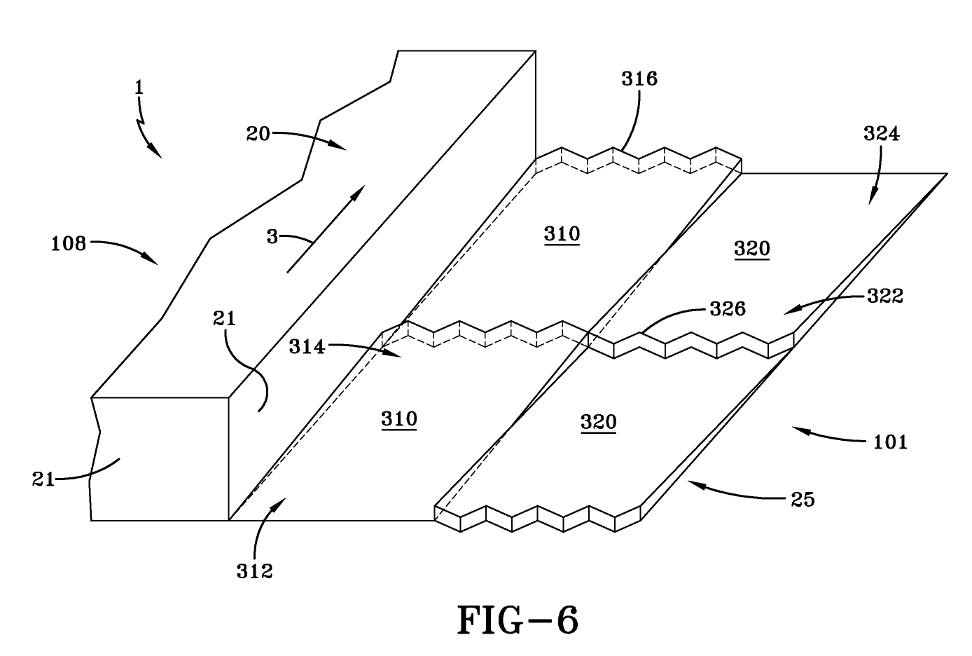

In another aspect of the invention, an edge portion 316 of a ramp structure 310 is saw-toothed (FIG. 6) and a second end portion 314 extends radially inward (as much as 5/32″) from the saw-toothed edge portion to a first end portion 312 of a circumferentially adjacent identical ramp structure 310. The ramp structure 310 has a planar inclined surface extending circumferentially from the first end portion 312 to the second end portion 314. A second ramp structure 320 of the matrix 101 extends circumferentially, from a radially outer first end portion 322, in a direction of rotation of the tire 1 and radially inward (as much as 5/32″) to a radially inner second end portion 324. The radially outer first end portion 322 defines a second saw-toothed edge portion 326 extending generally parallel to the axis of rotation of the tire 1 (FIG. 6). The second saw-toothed edge portion 326 improves traction of the tire 1 and evacuation of the circumferential and lateral grooves 16, 18, 22, 24, 30. The first ramp structure 310 and the second ramp structure 320 are disposed axially adjacent each other.

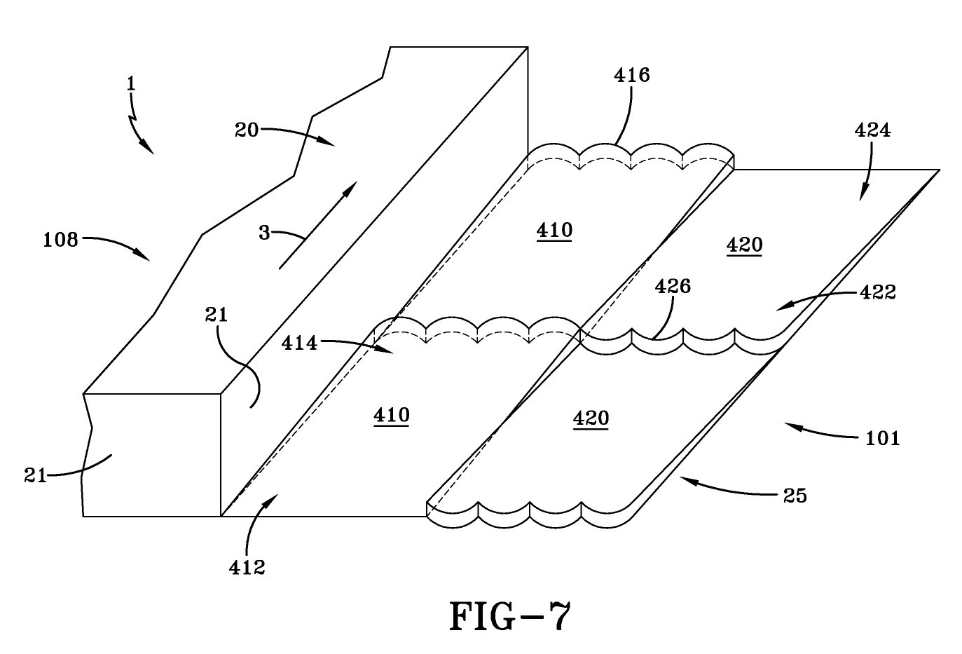

In another aspect of the invention, an edge portion 416 of a ramp structure 410 has multiple, circumferentially extending cylindrical projections and a second end portion 414 extends radially inward (as much as 5/32″) from the edge portion to a first end portion 412 of a circumferentially adjacent identical ramp structure 410 (FIG. 7). The cylindrical projections are shown as convex projections, but may also be concave projections. The ramp structure 410 has a planar inclined surface extending circumferentially from the first end portion 412 to the second end portion 414. A second ramp structure 420 of the matrix 101 extends circumferentially, from a radially outer first end portion 422, in a direction of rotation of the tire 1 and radially inward (as much as 5/32″) to a radially inner second end portion 424. The radially outer first end portion 422 defines a second edge portion 426 extending generally parallel to the axis of rotation of the tire 1 and also having multiple cylindrical projections. The second edge portion 426 improves traction of the tire 1 and evacuation of the circumferential and lateral grooves 16, 18, 22, 24, 30. The first ramp structure 410 and the second ramp structure 420 are disposed axially adjacent each other.

What is claimed is:

1. A pneumatic tire comprising an axis of rotation and a tread, the tread having a plurality of traction elements, a circumferential groove, and a lateral groove, the circumferential groove having a base interposed between radially extending sides formed by side walls of the traction elements, the lateral groove having a base interposed between radially extending sides formed by side walls of the traction elements, wherein the tire is further characterized by
the bases of the circumferential groove and the lateral groove each defining a matrix of circumferentially extending rectangular ramp structures, one ramp structure of the plurality extending circumferentially, from a radially inner first end portion, in a direction of rotation of the tire and radially outward to a radially outer second end portion, the radially outer second end portion defining an edge portion extending parallel to the axis of rotation of the tire, the edge portion improving traction of the tire and evacuation of the circumferential and lateral grooves.

2. The pneumatic tire of claim 1 further characterized by the edge portion of each ramp structure being linear and the second end portion extending radially inward from the edge portion to the first end portion of a circumferentially adjacent ramp structure.

3. The pneumatic tire of claim 2 further characterized by each ramp structure having a planar inclined surface extending circumferentially from the first end portion to the second end portion.

4. The pneumatic tire of claim 1 further characterized by a second ramp structure of the plurality extending circumferentially, from a radially outer first end portion, in a direction of rotation of the tire and radially inward to a radially inner second end portion, the radially outer first end portion defining a second edge portion extending parallel to the axis of rotation of the tire, the second edge portion improving traction of the tire and evacuation of the circumferential and lateral grooves.

5. The pneumatic tire of claim 4 further characterized by the first ramp structure and the second ramp structure being disposed axially adjacent each other.

6. The pneumatic tire of claim 1 further characterized by the edge portion of each ramp structure being concave toward the axis of rotation of the tire and the second end portion extending radially inward from the edge portion to the first end portion of a circumferentially adjacent ramp structure.

7. The pneumatic tire of claim 6 further characterized by each ramp structure having an inclined and rounded surface extending circumferentially from the first end portion to the second end portion.

8. The pneumatic tire of claim 6 further characterized by a second ramp structure of the plurality extending circumferentially, from a radially outer first end portion, in a direction of rotation of the tire and radially inward to a radially inner second end portion, the radially outer first end portion defining a second edge portion concave away from the axis of rotation of the tire and extending axially and radially relative to the axis of rotation of the tire, the second edge portion improving traction of the tire and evacuation of the circumferential and lateral grooves.

9. The pneumatic tire of claim 8 further characterized by the first ramp structure and the second ramp structure being disposed axially adjacent each other.

10. The pneumatic tire of claim 1 further characterized by the edge portion of each ramp structure being saw-toothed and the second end portion extending radially inward from the saw-toothed edge portion to the first end portion of a circumferentially adjacent ramp structure.

11. The pneumatic tire of claim 10 further characterized by each ramp structure having a planar inclined surface extending circumferentially from the first end portion to the second end portion.

12. The pneumatic tire of claim 10 further characterized by a second ramp structure of the plurality extending circumferentially, from a radially outer first end portion, in a direction of rotation of the tire and radially inward to a radially inner second end portion, the radially outer first end portion defining a second saw-toothed edge portion extending generally parallel to the axis of rotation of the tire, the second saw-toothed edge portion improving traction of the tire and evacuation of the circumferential and lateral grooves.

13. The pneumatic tire of claim 12 further characterized by the first ramp structure and the second ramp structure being disposed axially adjacent each other.

14. The pneumatic tire of claim 1 further characterized by the edge portion of each ramp structure having multiple cylindrical projections and the second end portion extending radially inward from the edge portion to the first end portion of a circumferentially adjacent ramp structure.

15. The pneumatic tire of claim 14 further characterized by each ramp structure having a planar inclined surface extending circumferentially from the first end portion to the second end portion.

16. The pneumatic tire of claim 14 further characterized by a second ramp structure of the plurality extending circumferentially, from a radially outer first end portion, in a direction of rotation of the tire and radially inward to a radially inner second end portion, the radially outer first end portion defining a second edge portion extending generally parallel to the axis of rotation of the tire, the second edge portion improving traction of the tire and evacuation of the circumferential and lateral grooves.

17. The pneumatic tire of claim 16 further characterized by the first ramp structure and the second ramp structure being disposed axially adjacent each other.
